(19) United States
(12) Patent Application Publication
(10) Pub. No.: US 2002/0010592 A1
(43) Pub. Date: Jan. 24, 2002

(54) Business deal information system

(76) Inventor: Nobuhiro Azuma, Bunkyo (JP)

Correspondence Address: STAAS & HALSEY LLP, 700 11TH STREET, NW, SUITE 500, WASHINGTON, DC, 20001, US

(21) Appl. No.: 09/817,225

(22) Filed: Mar. 27, 2001

(30) Foreign Application Priority Data
Jul. 21, 2000 (JP) 2000-221175

(51) Int. Cl. G06F 17/60

(52) U.S. Cl. 705/1; 705/26

(57) ABSTRACT

The present invention provides a business deal information system. This system includes a business deal information reception unit that receives business deal information containing a plurality of items, a registered member point file that manages the points held by each information provider, a confirmation information reception unit that receives information as to whether or not the contents of the business deal information received by the business deal information are accurate, and a point adder unit that adds a predetermined number of points to the number of points of the corresponding registered member in the registered member point file for each of the items confirmed to be accurate by the confirmation information reception unit.

### BACKGROUND OF THE INVENTION

1. Field of the Invention

The present invention generally relates to business deal information systems, and, more particularly, to a business deal information systems that provides business deal information, such as real estate dealing information, through the Internet.

2. Description of the Related Art

In the real estate business, “business deal information” provided through various routes plays a very important role, and holding such information effectively helps to win a larger number of orders. Therefore, real estate agencies actively try to obtain information by presenting cash to the information provider when a deal is closed, or by giving a gift to the information provider even when the deal is not closed.

However, such an information gathering operation is not put into a computer system, and has been mainly performed by hand.

Furthermore, the information gathering range is limited to the personal connection of each agent, and useful information cannot be quickly gathered in volume.

### SUMMARY OF THE INVENTION

A general object of the present invention is to provide business deal information providing systems in which the above disadvantages are eliminated.

A more specific object of the present invention is to provide a business deal information providing system in which many and unspecified persons, besides the personal connection of a real estate agent, can provide business information that helps to close as many deals as possible.

The above objects of the present invention are achieved by a business deal information system. In this system, the number of points is set for each of the items of business deal information provided. The number of points is added up only when the provided business deal information is accurate. Also, when a deal is closed, a predetermined number of points is added, so as to give some incentive to information providers. The points are exchangeable for predetermined gift items.

The above and other objects and features of the present invention will become more apparent from the following description taken in conjunction with the accompanying drawings.

### BRIEF DESCRIPTION OF THE DRAWINGS

FIG. 1 shows the structure of a system as one embodiment of the present invention;

FIG. 2 shows the structure of a server;

FIG. 3 shows an example of a provided information registration screen;

FIG. 4 shows an example of a confirmation information registration screen;

FIG. 5 shows an example of a point definition table;

FIG. 6 shows an example of a registered member point file;

FIG. 7 shows the structure of a business information database;

FIG. 8 is a flowchart of a provided information registration CGI program;

FIG. 9 is a flowchart of a confirmation information registration CGI program;

FIG. 10 is a flowchart of a point confirmation CGI program; and

FIG. 11 is a flowchart of a closed deal registration program.

### DESCRIPTION OF THE PREFERRED EMBODIMENTS

The following is a description of embodiments of the present invention, with reference to the accompanying drawings.

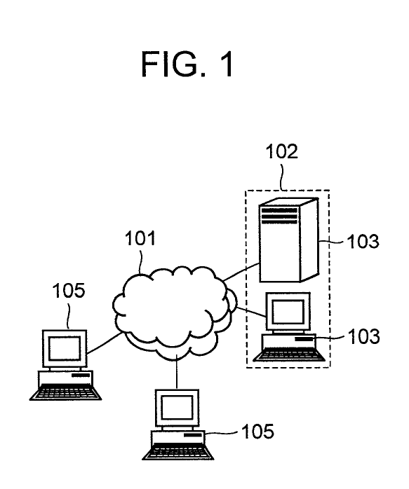

FIG. 1 shows the structure of a system as one embodiment of the present invention. In this figure, reference numeral 101 indicates the Internet, which is a network connected on the world scale. Reference numeral 102 indicates a dealer system that includes a dealer server 103 and an agent terminal 104. The dealer server 103 will be described later in detail. Reference numeral 105 indicates a user terminal that is connected to the Internet 101 and accesses the trader server 103 via the Web browser.

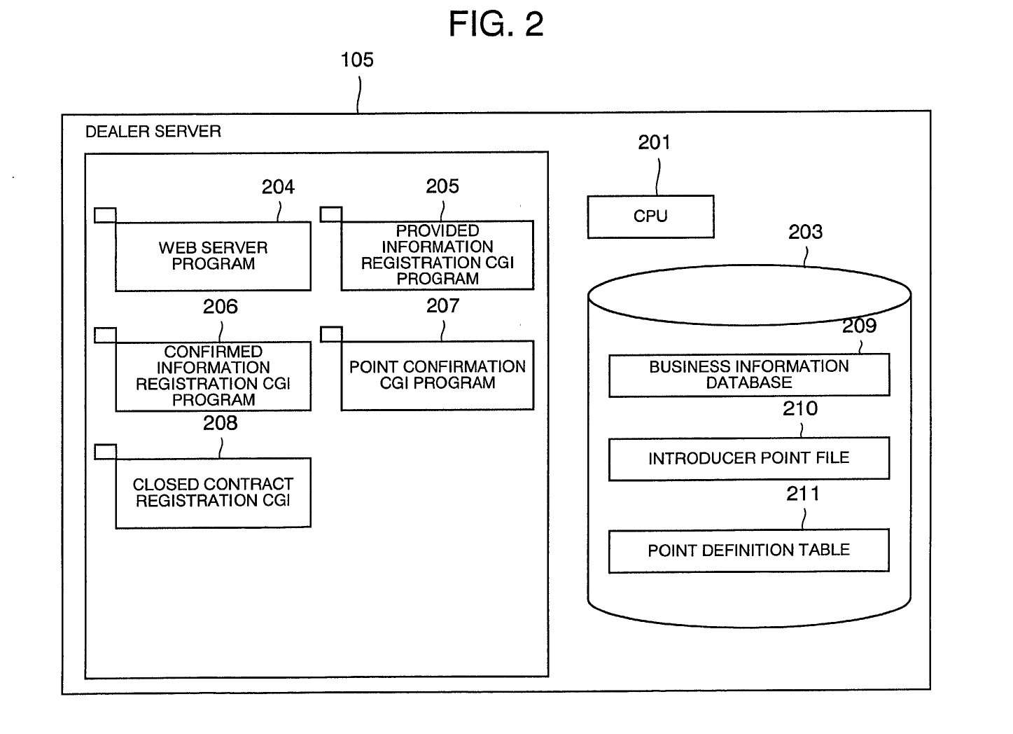

FIG. 2 shows the structure of the trader server 103. The trader server 103 is a general computer, and comprises a CPU 201, a memory (main memory) 202, and an external storage device 203.

A Web server program 204, a provided information registration CGI program 205, a confirmation information registration program 206, a point confirmation CGI program 207, and a closed deal registration CGI program 208 are loaded into the memory 202 and executed by the CPU 201.

Besides the above programs, the external storage device 203 stores a business information database 209, an introducer point file 210, and a point definition table 211.

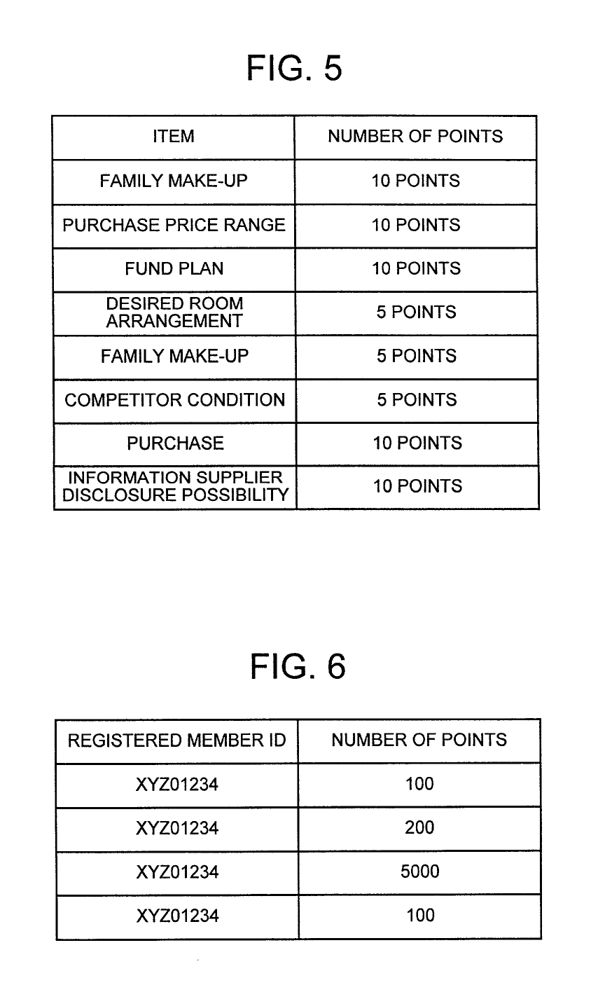

FIG. 5 shows an example of the point definition table, which includes a plurality of records each consisting of an item and the corresponding number of points.

The number of points is added up every time accurate information is registered with the corresponding item.

FIG. 6 shows an example of the introducer point file 210, which includes a plurality or records each consisting of a registered member ID and the corresponding number of points.

The number of points indicates how many points the person identified with the registered member ID has earned so far through the use of the business deal information system of the present invention.

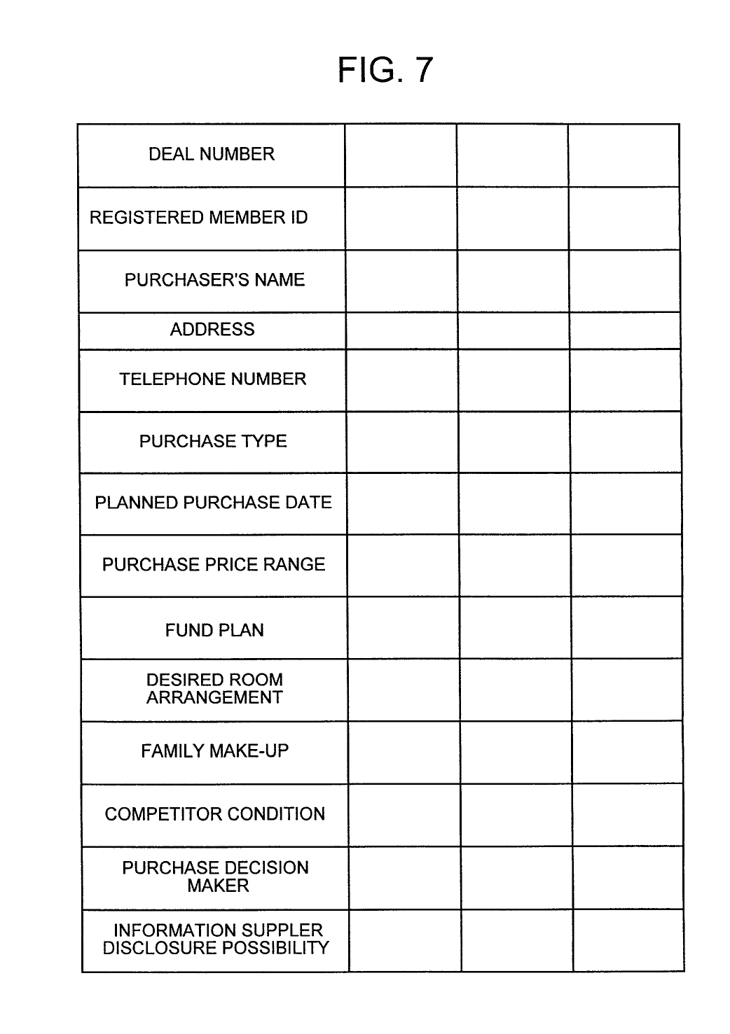

FIG. 7 shows the structure of the business information database 209, which include a plurality of records each consisting of a deal number, a registered member ID, the name of a purchaser, the address and telephone number of the purchaser, a desired type of house, a planned purchase date, a desired price range, funds, desired room arrangement, a family make-up, competitor conditions, a purchase decision maker, and a possibility of information supplier disclosure.

The Web server program 204 is a known program for transferring data requested by a command using URL (Uniform Resource Locators) to a terminal device that has made the request in accordance with a known HTTP protocol. The URL comprises information for identifying a server and information for identifying data in the server.

The URL may also comprise information for identifying a server, information for identifying a program in the server, and parameters to be used in the program. Such a program designated in the URL is normally called a CGI program.

A registered member to register introduction information accesses the dealer server 103 using a Web browser program executed by the user terminal 105. More specifically, the URL of “provided information input screen” for registering introduction information is designated, so that the provided information input screen is displayed on the user terminal by the dealer server 103.

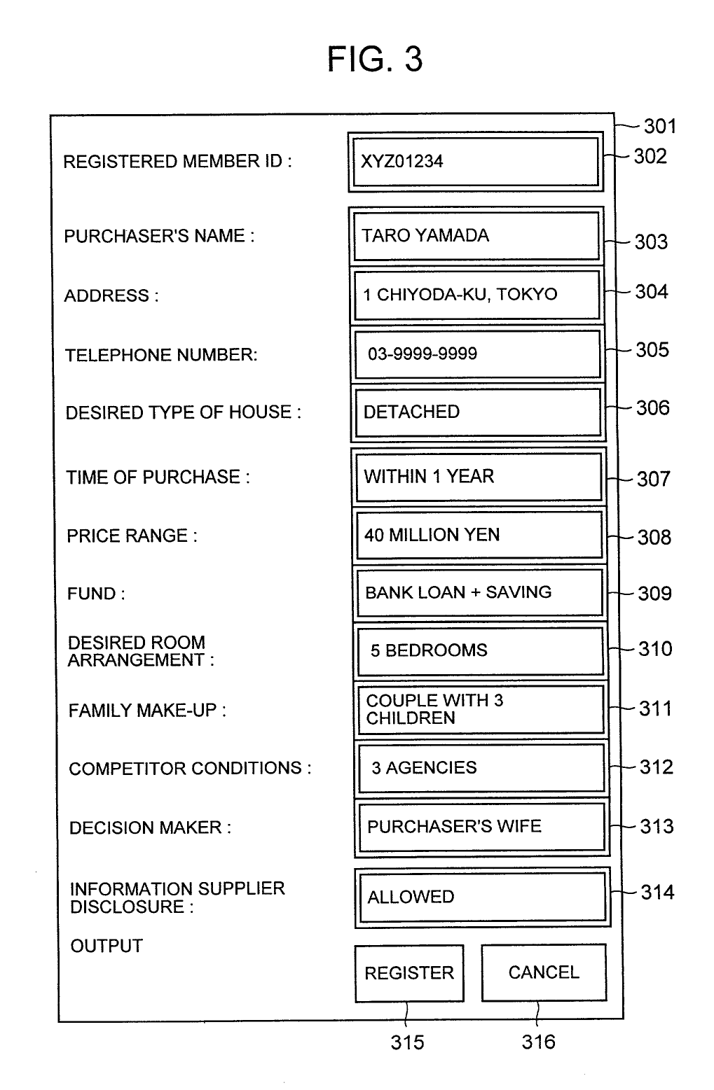

FIG. 3 shows an example of a provided information input screen shown on the user terminal 105. The provided information input screen 301 comprises a registered member ID input field 302, a purchaser's name input field 303, an address input field 304, a telephone number input field 305, a purchase type input field 306, a planned purchase date input field 307, a price range input field 308, a fund input field 309, a desired room arrangement input field 310, a family make-up input field 311, a competitor condition input field 312, a purchase decision maker input field 313, an information supplier disclosure possibility input field 314, a registration button 315, and a cancel button 316.

The registered member ID input field 302 is a field in which a registered member ID for identifying an information supplier is inputted.

The purchaser's name input field 303 is a field in which the name of a purchaser is inputted.

The address input field 304 is a field in which the address of a purchaser is inputted.

The telephone number input field 305 is a field in which contact information such as the telephone number of a purchaser is inputted.

The purchase type input field 306 is a field in which the desired type of house to be purchased is inputted.

The planned purchase date input field 307 is a field in which a rough date on which the purchaser plans to buy a house is inputted.

The price range input field 308 is a field in which a desired price range is inputted.

The fund input field 309 is a field in which a fund plan of the purchaser is inputted.

The desired room arrangement input field 310 is a field in which desired room arrangement is inputted.

The family make-up field 311 is a field in which the make-up of a family to live in a purchased house is inputted.

The competitor condition input field 312 is a field in which the number of other dealers to which the purchaser has talked, i.e., the number of competitors to which the purchaser has talked about the house purchasing plan, is inputted.

The purchase decision maker input field 313 is a field in which the name of a person who is to make the final decision on the purchase is inputted.

The information supplier disclosure possibility field 314 is a field in which whether or not it is allowed to let the purchaser know that the agent has made a contact with the purchaser based on the information registered by a registered member is inputted. Notifying a purchaser of an introducer relaxes the purchaser, and leads to smooth communication between the agent and the purchaser.

The registration button 315 is a button for instructing to register the inputted data of the above fields in the business deal information database 209 of the dealer server 103. By clicking the registration button 315 with a mouse, the data is registered in the business deal information database 209.

The cancel button 316 is clicked when no data is actually stored in the business deal information-database 209, though the data has been inputted in the fields.

When an information register inputs data in the above fields and then clicks the registration button 315, the Web browser executed on the user terminal 105 constructs URL (Uniform Resource Locators), using the information for identifying the dealer server 103 defined in advance by the registration button 316, the information for identifying the provided information registration CGI program 205, and the inputted data of the fields as parameters for the provided information registration CGI program 205. The constructed URL are transmitted to the dealer server 103 in accordance with the HTTP protocol.

If the URL supplied from the user terminal 105 contains the information for identifying the provided information registration CGI program 205 and the corresponding parameters, the Web server program 204 of the dealer server 104 starts the provided information registration CGI program 205 and transfers the parameters.

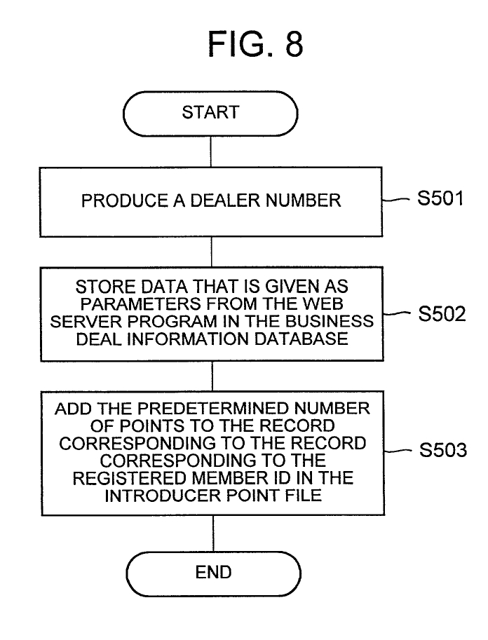

The started provided information registration CGI program operation in accordance with the flowchart shown in FIG. 8. First, in step S501, a deal number is generated. In step S502, a record is generated based on the deal number generated in step S501 and the parameters supplied from the Web server program 204. The record is then stored in the business deal information database 209.

In step S503, it is determined whether or not the necessary information, such as the purchaser's name, address, telephone number, and the type of purchase, is found. If the necessary information is found, five hundred points are added as the starting points to the number of points in the record corresponding to the registered member ID in the introducer point file.

As the business deal information is registered, an agent contacts the purchaser based on the registered information. If the registered information contains the information of a large number of purchasers, a priority order is put to the purchasers in accordance with the contents of the business deal information (the price range, for instance), so that the agent can first make contact with the purchaser that is given the highest priority.

The agent then actually make contact with each purchaser, and checks whether or not the business deal information registered by the registered member is accurate. The agent then registers the check result in the dealer server 103. The registration is carried out in the following manner.

The agent accesses the dealer server 103 using the Web browser executed on the agent terminal 104. More specifically, to register the confirmation information as to whether or not the registered business deal information is accurate, the URL of the “confirmation information registration screen” is designated by the Web browser, thereby displaying the provided information input screen on the user terminal by the dealer server 103.

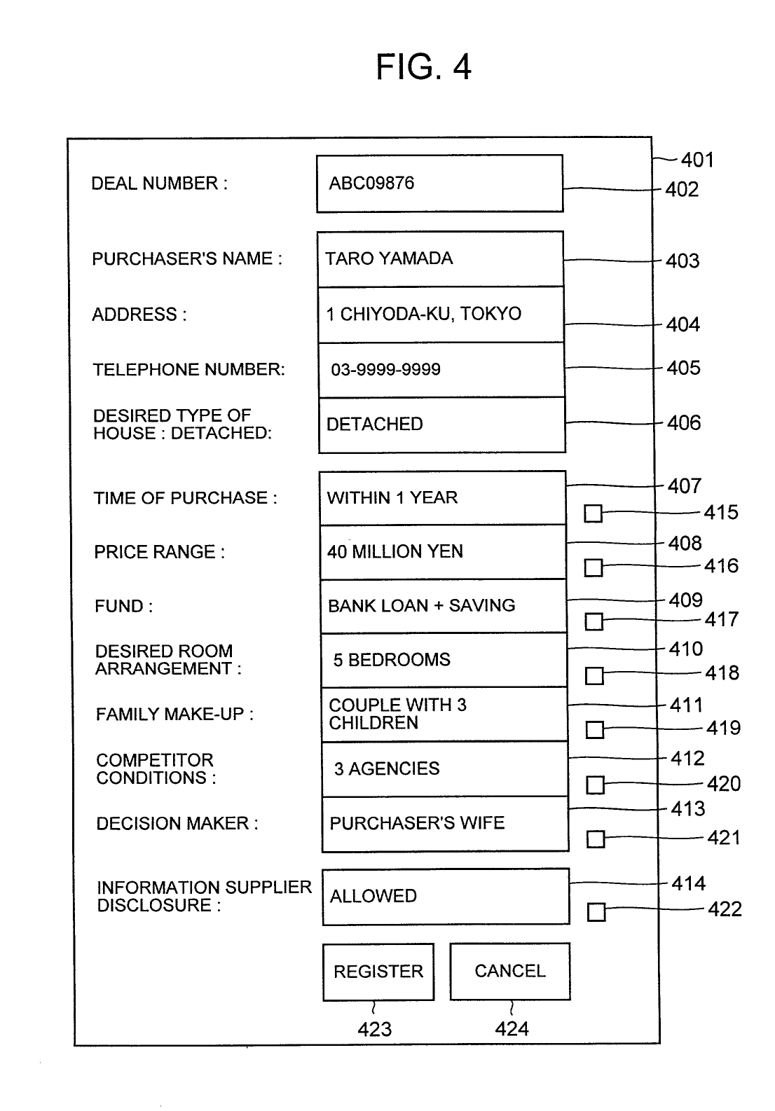

FIG. 4 shows an example of the confirmation information input screen displayed on the agent terminal 104. This confirmation information input screen 401 includes a business deal number input/output field 402, a purchaser's name display field 403, an address display field 404, a telephone number display field 405, a desired purchase type display field 406, a planned purchase date display field 407, a purchase price range display field 408, a fund display field 409, a desired room arrangement display field 410, a family make-up display field 411, a competitor condition display field 412, a purchase decision maker display field 413, an information supplier disclosure possibility display field 414, a planned purchase date confirmation check box 415, a purchase price range confirmation check box 416, a fund plan confirmation check box 417, a desired room arrangement confirmation check box 418, a family make-up confirmation check box 419, a competitor condition confirmation check box 420, a purchase decision maker confirmation check box 421, an information supplier disclosure possibility confirmation check box 422, a registration button 423, and a cancel button 424.

The deal number input/output field 402 is a field in which a business deal number is inputted.

The purchaser's name display field 403 is a field for displaying the name of a purchaser registered by a registered member.

The address display field 404 is a field for displaying the address of a purchaser registered by a registered member.

The telephone number display field 405 is a field for displaying a telephone number of a purchaser registered by a registered member.

The desired purchase type display field 406 is a field for displaying a type of house desired by a purchaser registered by a registered member.

The planned purchase date display field 407 is a field for displaying a purchase date planned by a purchaser registered by a registered member.

The purchase price range display field 408 is a field for displaying a purchase price range planned by a purchaser registered by a registered member.

The fund plan display field 409 is a field for displaying a fund plan of a purchaser registered by a registered member.

The desired room arrangement display field 410 is a field for displaying room arrangement desired by a purchaser registered by a registered member.

The family make-up display field 411 is a field for displaying the make-up of a family to live in a house to be purchased. The family is registered by a registered member.

The competitor condition display field 412 is a field for displaying competitor information registered by a registered member.

The purchase decision maker display field 413 is a field for displaying who is to make the final decision on the purchase registered by a registered member.

The information supplier disclosure possibility display field 414 is a field for displaying whether or not the disclosure of an information supplier is allowed.

The planned purchase date confirmation check box 415 is a check box In which the judgment result of whether or not a planned purchase date registered by a registered member is the same as a planned purchase date confirmed by an agent is inputted by the agent.

The purchase price range confirmation check box 416 is a check box in which the judgment result of whether or not a price range registered by a registered member is the same as a price range confirmed by an agent is inputted by the agent.

The fund plan confirmation check box 417 is a check box in which the judgment result of whether or not a fund plan registered by a registered member is the same as a fund plan confirmed by an agent is inputted by the agent.

The desired room arrangement confirmation check box 418 is a check box in which the judgment result of whether or not desired room arrangement registered by a registered member is the same as desired room arrangement confirmed by an agent is inputted by the agent.

The family make-up confirmation check box 419 is a check box in which the judgment result of whether or not the make-up of a family registered by a registered member is the same as the make-up of a family confirmed by an agent is inputted by the agent.

The competitor condition confirmation check box 420 is a check box in which the judgment result of whether or not information as to a purchaser registered by a registered member is the same as information confirmed by an agent is inputted by the agent.

The purchase decision maker confirmation check box 421 is a check box in which information as to a purchase decision maker registered by a registered member is the same as information confirmed by an agent is inputted by the agent.

Each of the check boxes is a GUI (Graphical User Interface) for checking each item. A checked check box indicates consistency, while a unchecked check box indicates inconsistency.

The registration button 423 is a button for instructing to update the introducer point file of the dealer server based on the check results of the check boxes. By clicking the registration button 423 with a mouse, the introducer point file 210 can be updated.

The cancel button 424 is clicked when the check results are not reflected in the introducer point file 210 of the dealer server.

When an agent checks the check boxes and clicks the registration button 423, the Web browser executed on the agent terminal 104 constructs URL, using the information for identifying the dealer server 103 defined in advance, the information for identifying the confirmation information registration CGI program 206, the deal numbers, and the check results of the check boxes as parameters. The constructed URL are transmitted to the dealer server 103 in accordance with the HTTP protocol.

If the transmitted URL contains the information for identifying the confirmation information registration CGI program 206 and the corresponding parameters, the Web server program 204 of the dealer server 103 starts the confirmation information registration CGI program 206 and transfers the parameters.

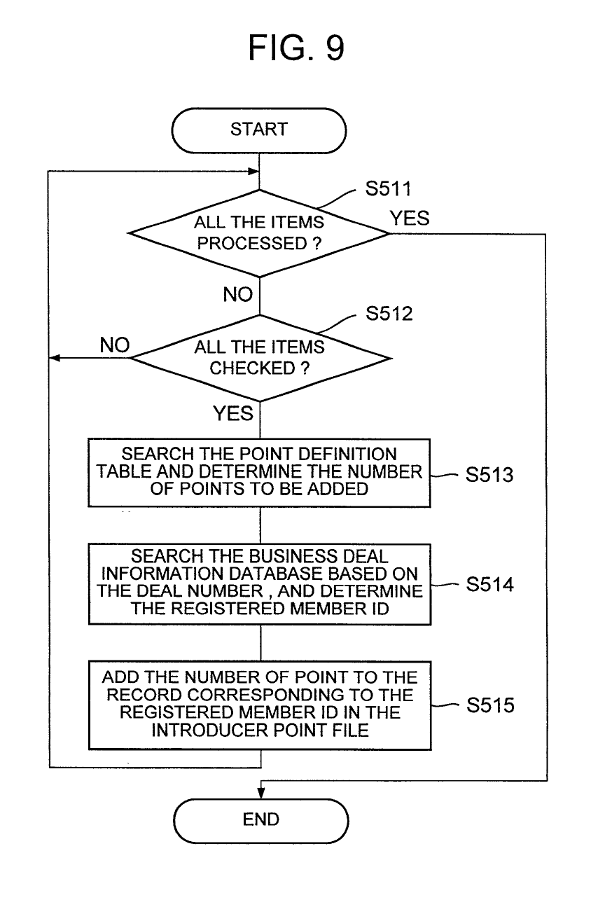

The started confirmation information registration CGI program 206 operation in accordance with the flowchart shown in FIG. 9. The procedures from step S512 to step S515 are repeated for all the check boxes. In step S511, it is determined whether or not the procedures have been repeated for all the check boxes.

In step S512, it is determined whether or not the check box of an item to be processed is checked. If it is not checked, the check box of the next item is processed.

If the corresponding check box is checked, steps S513 to S515 are carried out.

In step S513, the point definition table 211 is searched, and the number of points to be added is determined. In step S514, based on the deal number supplied as a parameter from the Web server, the business deal information database is searched and the registered member ID of a designated record is determined. Finally, the number of points determined in step S513 is added to the record corresponding to the registered member ID in the introducer point file 210.

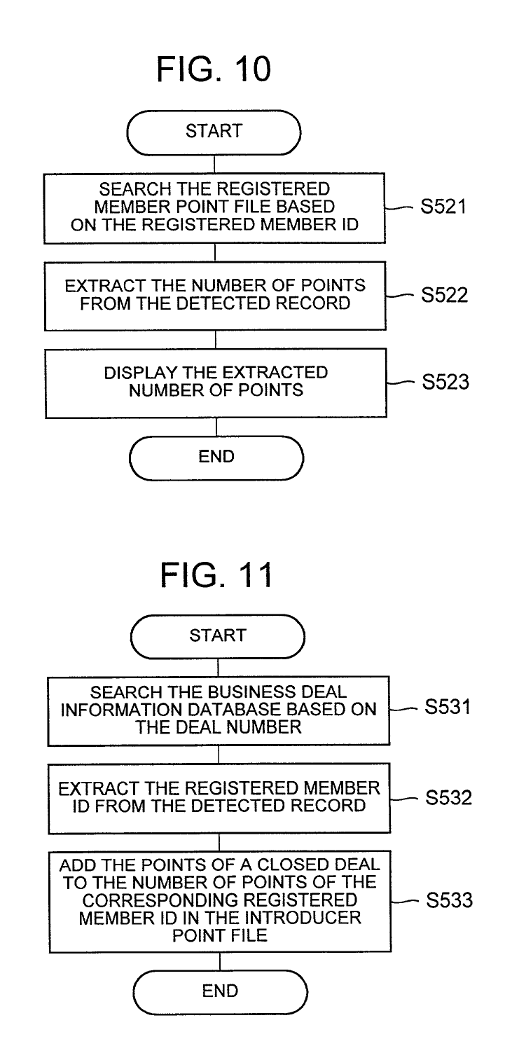

FIG. 10 is a flowchart of an operation performed by the point confirmation CGI program 207. When a registered member ID is transferred ass a parameter from the Web browser executed on the user terminal 105, the registered member point file is searched based on the registered member ID in step S521. In step S552, the number of points is extracted from a record that has been designated as a result of the search. In step S523, the extracted number of points is displayed on the screen, and the operation comes to an end.

FIG. 11 is a flowchart of an operation performed by the closed deal registration CGI program 208. When a business deal ID is transferred as a parameter from the Web browser executed on the agent terminal 104, the business deal information database is searched based on the deal number in step S531. In step S532, a registered member ID is extracted from the record designated as a result of the search. In step S533, 2000 points are added as closed deal points to the number of points of the corresponding registered member ID in the introducer point file. The operation then comes an end.

In this manner, the number of points of each registered member is added up.

The present invention is not limited to the specifically disclosed embodiments, but variations and modifications may be made without departing from the scope of the present invention.

The present application is based on Japanese priority application No. 2000-221175, filed on Jul. 21, 2000, the entire contents of which are hereby incorporated by reference.

What is claimed is:

1. A business deal information system comprising:
a business information reception unit that receives business information containing a plurality of items;
a registered member point file that manages points held by each business information supplier;
a confirmation information reception unit that receives information indicating whether or not the contents of the plurality of items received by the business information reception unit are accurate; and
a point adder unit that adds a predetermined number of points to the number of points of a corresponding registered member registered in the registered member point file for each of the items confirmed by the confirmation information reception unit.

2. A business deal information management method of managing the number of points of each registered member in accordance with a registered member point file, said method comprising the steps of:
receiving information indicating whether or not the contents of each of items that constitutes business information supplied from a registered member are accurate; and
adding a predetermined number of points to the number of points of a corresponding registered member for each of the items confirmed to be accurate.
